(19) United States
(12) Patent Application Publication
(10) Pub. No.: US 2022/0167549 A1
(43) Pub. Date: Jun. 2, 2022

(54) AGRICULTURAL EQUIPMENT FOR DISTRIBUTION OF PRODUCT, SUCH AS A MIXER COMPRISING A TANK HAVING AT LEAST ONE DISCHARGE OPENING

(71) Applicant: KUHN-AUDUREAU SAS, La Copechagniere (FR)

(72) Inventors: Loïc Toulotte, La Chapelle Sur Erdre (FR); Nicolas Pele, La Chapelle Sur Erdre (FR)

(73) Assignee: KUHN-AUDUREAU SAS, La Copechagniere (FR)

(21) Appl. No.: 17/456,189

(22) Filed: Nov. 23, 2021

(30) Foreign Application Priority Data
Nov. 30, 2020 (FR) 20 12407

(51) Int. Cl. A01C 7/20; A01C 17/00

(52) U.S. Cl. CPC A01C 7/208; A01C 17/00

(57) ABSTRACT

An agricultural equipment for distribution of product, such as a mixer, including a tank having at least one discharge opening, a bottom and a lateral wall, mounted on a chassis and provided with at least one discharge opening made in the lateral wall and defining a passage of rectangular shape, wherein a rotary drive mechanism that conveys the product through the opening is mounted in the tank and defines the first and second lateral rims of the opening in the direction of rotation of the mechanism. The discharge opening is provided in the region of the second lateral wall with at least one surface-occupying or volume-occupying obstructive structure that reduces the passage cross section of the opening and/or determines the geometry of this second rim at least partly.

The present invention relates to the field of agricultural machinery and installations, more particularly equipment for distribution of materials from a mobile or fixed container, especially animal fodder products, in particular mixtures based on silage or other feed, in stables or the like.

It is known that the mixers usually have a discharge opening of generally quadrilateral, usually rectangular shape, provided in the tank wall (for example, see Reference 3 in the document EP3345475A1). During the transfer of the product (mixture) contained in the tank toward the outside via the discharge opening, accumulation of product is observed in the corner(s) of this opening in the region of its second rim, against which the mixing screw conveys the product (this is the second rim to be traversed during displacement of the mixing/discharge mechanism). The mixed product transported by the slowly turning mixing/discharge mechanism can become trapped in such so-called dead corner(s) and accumulate there. Sometimes a “solid bridge” is formed by agglomeration/aggregation of discharged product as it accumulates progressively from the region of the bottom of the second side and becomes fixed there (normally on the same level as the tank bottom): the discharge process may then be stopped completely, or more frequently the discharged quantity is greatly reduced or varies with time, and the target discharge rate is not maintained throughout the operation.

Furthermore, the discharge opening is traditionally closed by a slide or by a door, which slides along a trajectory following the tank wall. This slide has a shape that corresponds to the shape of the wall: the slide will be fairly straight if it is placed on the lateral wall (of a tank having generally elliptical shape) and will have some curvature if it is placed on the front wall of this tank (same radius of curvature). When product has accumulated in the critical zone of the door, the slide is no longer able to close the discharge opening completely, and so product will be able to fall to the ground through the portion of the opening that is not closed off. To remedy this malfunction, the driver must descend from the tractor to clear the clogged zone and permit the discharge opening to be completely closed off again by means of the slide.

The document EP 1,671,538 proposes the use of a mobile auxiliary mechanism situated (with an approximately vertical axle) directly in the zone of the second rim of the opening. This rotary mechanism, in the form of a roller with fingers, requires a drive to keep the zone clear and to transport the product (rapidly) through the discharge opening. It is placed directly adjacent to the second opening rim, on the outside of the discharge opening, and it functions within part of the height range of the discharge or over the entire height of the discharge opening. Thus, regardless of the quantity of product that the mixing screw delivers to the discharge opening per unit time, a uniform and measured transport flow toward the outside can be guaranteed, and no product is able to become fixed on the critical second opening rim. Nevertheless, this solution requires on the one hand a rocker-type structure for disposing the mechanism at the level of the critical zone of the opening and on the other hand the installation of a drive for the rotary auxiliary mechanism. Consequently: a risk of degradation of the auxiliary mechanism and possibly of the slide if this latter is shifted into closed position before the rotary auxiliary mechanism has been moved apart from the opening. What is more, such an additional system is costly and necessitates precise adjustment of its distance from the opening as well as adaptation of the speed as a function of the type of mixed product being discharged, in order to prevent the discharged product from being projected too far.

The general object of the present invention is to propose a simpler, less costly solution that does not need any positive intervention or action for its use, while also making it possible to remedy the accumulation of discharged product and the creation of solid bridges effectively. More precisely, compared with the document EP 1,671,538 in particular, the object is to propose a simpler alternative with less adjustment and maintenance, thus making it possible to prevent accumulations in the region of the discharge opening and permitting uniform discharge of the product.

For this purpose, the object of the invention is an agricultural equipment for distribution of product, such as a mixer comprising a tank having a bottom and a lateral wall mounted on a chassis and provided with at least one discharge opening made in the said lateral wall and defining a passage of general quadrilateral, preferably rectangular shape, wherein a rotary drive mechanism that conveys the product through the opening is mounted in the said tank and defines the first and second lateral rims of the said opening in the direction of rotation of the said mechanism, which equipment is characterized in that the said discharge opening is provided in the region of the said second lateral rim with at least one surface-occupying or volume-occupying obstructive structure that reduces the passage cross section of the said opening and/or determines the geometry of this second rim at least partly.

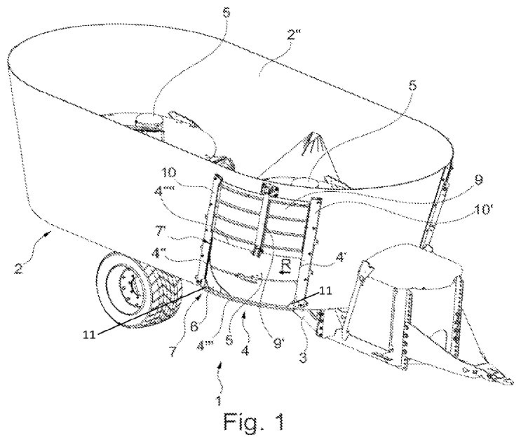

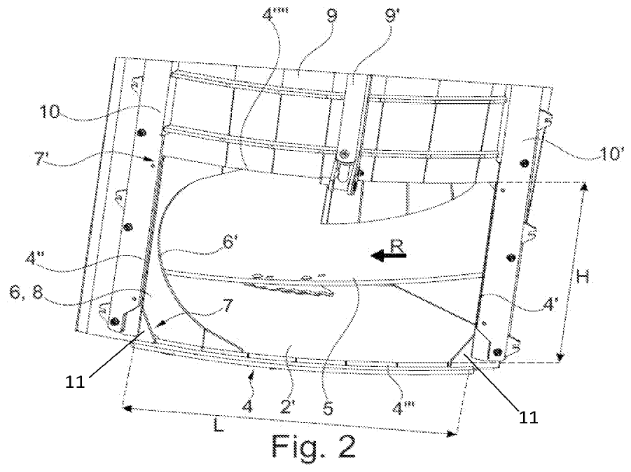

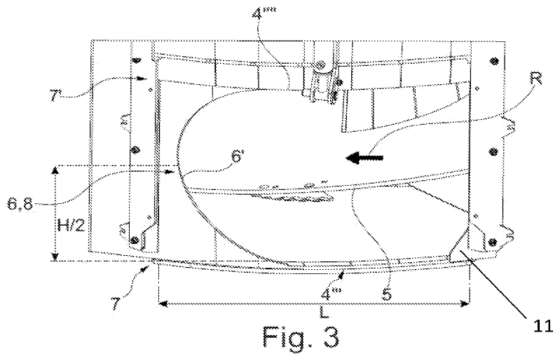

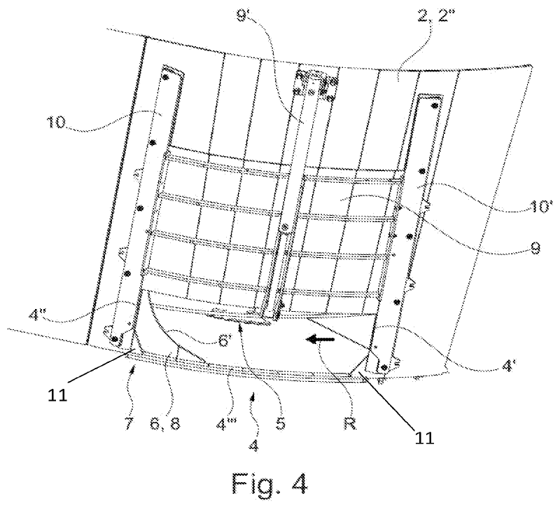

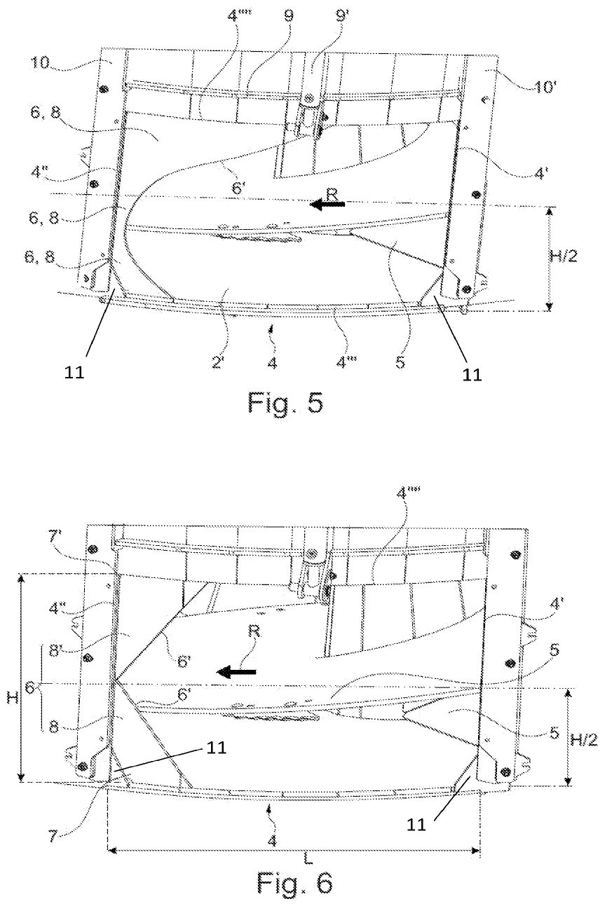

The invention will be better understood by virtue of the description hereinafter, which relates to a preferred embodiment, provided by way of non-limitative example, and will be explained with reference to the attached schematic drawings, wherein:

[FIG. 1] represents, viewed in perspective, an exemplary agricultural equipment in the form of a towed mixer, in accordance with the invention and illustrating a first variant embodiment of the invention;

[FIG. 2] is a partial detail view in elevation and on a different scale of the region of the discharge opening of the tank of the equipment shown in FIG. 1, in accordance with a second variant embodiment of the invention;

[FIG. 3] is a partial detail view of the region of the discharge opening of the tank of the equipment comparable to FIG. 2, in accordance with a third variant embodiment of the invention;

[FIG. 4] is a detail view of the region of the discharge opening of the tank of the equipment according to one of the variant embodiments of the invention such as illustrated by FIGS. 1 and 2, wherein the discharge opening is halfway closed;

[FIG. 5] is a detail view of the region of the discharge opening of the tank of the equipment according to a fourth variant embodiment of the invention;

[FIG. 6] is a detail view similar to those of FIGS. 2, 3 and 5, illustrating a fifth variant embodiment of the invention.

FIG. 1 and partly FIGS. 2 to 6 show an agricultural equipment (1) for distribution of product in the form of a mixer, in accordance with a non-limitative embodiment of the invention.

This equipment (1) comprises a tank (2) having a bottom (2′) and a lateral wall (2″), mounted on a chassis (3). Although this chassis (1) in the example shown in FIG. 1 consists of a rolling chassis (in this case towed with a drawbar, but possibly also self-propelled), the invention may likewise be applied to an equipment having a stationary chassis (not shown).

The tank (2) is provided with at least one discharge opening (4) made in its lateral wall (2″) and defining a passage of general quadrilateral, preferably rectangular shape. The tank (2) may have a circular or elliptical shape in cross section and the opening (4) may be situated in the region of a substantially flat part or more frequently in the region of a curved part of the wall (2″), wherein its lower rim (4″′) is situated in the continuation of the bottom (2′) of the tank (2) and is flush with that bottom. Thus, especially when the opening is rectangular, the lateral rims (4′ and 4″) of the opening are always vertical and straight, whereas the upper rim (4″″) may be straight or curved. Alternatively, the discharge opening (4) made in the tank (2) may be of square shape or may reproduce the shape of any quadrilateral whatsoever.

A rotary drive mechanism (5) that conveys the product (in bulk) through the opening (4) is mounted in the said tank (2) and defines, for the said opening (4), first and second lateral rims (4′ and 4″) according to the direction of rotation (R) of the said mechanism (5). Thus the product to be discharged will be pushed through the opening (4) while being simultaneously directed toward the said second rim (4″).

This rotary mechanism (5) is mounted to move and rotate around a vertical axle that is perpendicular relative to the plane of the bottom (2′). The function of such a rotary mechanism (5) is, for example, to mix and aerate the product, to distribute the product in the tank, to scrape the bottom of the tank (2) and/or to eject the product through the discharge opening (4). Advantageously, the rotary mechanism (5) is a helicoidal screw, which tapers upward. Alternatively, the rotary mechanism is a mobile mechanism comprising one or more radial arms. Two rotary mechanisms (5) of the mixing screw type, disposed one behind the other, are mounted in the tank (2) of the mixer shown in FIG. 1. A discharge opening (4) may be associated with each mechanism (5), or else only one of the two mechanisms (the front mechanism in FIG. 1) is associated with such an opening (4) to ensure a discharge function.

According to the invention, the said discharge opening (4) is provided at the level of the said second lateral rim (4″) with at least one surface-occupying or volume-occupying obstructive structure (6) that reduces the passage cross section of the said opening (4) and/or determines the geometry of this second rim (4″) at least partly.

This obstructive structure (6) disposed in the region of the second rim (4″) of the opening (4) of quadrilateral shape constitutes a simple static and passive device for diverting the flow of product through that opening. Its mere presence at that location, possibly combined with a special shape such as described hereinafter, prevents/limits accumulation of the product in that zone of the second opening rim, which favors such a phenomenon.

By virtue of this obstructive and deflecting structure of the invention, the dynamics of discharge of the product are better regardless of the discharge height (which may be a function of the position of the vertically displaceable closing slide). Due to this fact, regardless of the quantity of product that the rotary drive and conveying mechanism (5) delivers to the discharge opening (4) per unit time (tank, full, half full or almost empty), a more or less uniform distribution flow results.

In addition, the proposed solution is of simple construction, is easy to implement (even on existing equipment), is inexpensive, is devoid of moving parts, is robust and requires virtually no maintenance.

Preferably, and by way of favorable compromise between a sufficient action against accumulation of product and limited reduction of the maximum flow of product to be discharged, the reduction of passage cross section of the discharge opening (4) resulting from the presence of the said at least one obstructive structure (6) is greater than 2% and less than 20% of the said passage cross section, and is preferably between 2% and 15%. If applicable, the present invention may provide that the reduction of passage cross section of the discharge opening (4) resulting from the presence of the said at least one obstructive structure (6) is greater than 1% and less than 20% of the said passage cross section, and is preferably between 2% and 15%.

In accordance with a first important constructive characteristic of the invention, and according to the example shown in FIG. 1, the obstructive structure (6) is situated at least partly at the level of the lower corner (7) of the discharge opening (4), formed between the second lateral rim (4″) and the lower longitudinal rim (4″′) of the opening (4). This rim (4″′) is advantageously situated in the plane of the bottom (2′) of the tank (2) and is flush with the said bottom.

In accordance with the variant shown in FIG. 1, the obstructive structure (6) is, for example, a portion of plate of triangular shape, with a concavely curved hypotenuse. The obstructive structure (6) extends from the angle of the lower corner (7) to approximately half of the height (H) of the discharge opening (4) and to approximately one quarter of the width (L). Preferably, the obstructive structure (6) extends from the angle of the lower corner (7) to a value between one fifteenth and one quarter of the width (L) and to a value between one eighth and one half of the height (H) of the discharge opening (4).

Particularly advantageously, the present invention may have a single obstructive structure (6), which is disposed/installed at the level of the lower corner (7) of the discharge opening (4), formed between the second lateral rim (4″) and the lower longitudinal rim (4″′) of the opening (4). The present invention may then provide, for example, that the said obstructive structure (6) of the said lower corner (7) extends in width from the said lower corner to a width between one fifteenth and one quarter of the width (L) of the discharge opening (4) and in height to a height between one eighth and one half of the height (H) of the discharge opening (4). This obstructive structure (6) is intended to reduce the passage cross section of the discharge opening (4) by at least 2%, preferably by at least 1%, with the objective of diverting and thus preventing the accumulation of product in the lower corner (7).

The discharge opening (4) may have, for example, a width between the first lateral rim (4′) and the second lateral rim (4″) of approximately 1000 mm and a height between the lower rim (4′″) and the upper rim (4″″) of approximately 700 mm. Ordinarily, the dimensions of the discharge opening (4) of known agricultural equipment for distribution of products are between 600 and 800 mm for height and between 800 and 1200 mm for width.

In accordance with another important constructive characteristic of the invention, advantageously in addition to the aforesaid first characteristic or possibly alternatively thereto, the obstructive structure (6) is situated at least partly at the level of the upper corner (7′) of the discharge opening (4) formed between the second lateral rim (4″) and the upper longitudinal rim (4″″) of the said opening (4).

FIGS. 2 and 3 each illustrate an obstructive structure (6) situated at the level of the lower corner (7) and an obstructive structure (6) situated at the level of the upper corner (7′) of the discharge opening (4). The two obstructive structures (6)—lower and upper—are advantageously joined in the region of their junction. They may be advantageously made in one single piece (8) as shown in these two figures, in which case they constitute a single obstructive structure having double action (it will then be possible to describe them as upper and lower parts of the single structure in association with the corner in question). Alternatively, it is also possible for each to be formed by a specific piece (8 and 8′), which are mutually arranged in joined and continuous manner.

It follows from the different constructive variants shown that the or each obstructive structure (6) has a functional or leading rim (6′) defining at least part of a rim profile of the discharge opening (4) opposite the first rim (4′) thereof.

FIG. 2 illustrates an obstructive structure (6) in the form of a portion of plate, the profile of which is curved with regard to the first lateral rim (4′). Thus the profile is C-shaped. The lower obstructive structure (6) (or lower part) has a larger surface than the upper obstructive structure (6) (or upper part). FIG. 3 illustrates a variant of the profile of FIG. 2, in which the surfaces of the two parts of the obstructive structure (6) are larger. The obstructive structure (6) or lower part extends to approximately half of the width (L) of the discharge opening (4). It will also be noted that the junction zone at the level of half (H/2) of the height (H) of the opening (4) is larger in FIG. 3 than in the example of FIG. 2.

In the constructions mentioned in the foregoing, the said or each obstructive structure (6) consists advantageously of a portion of plate having a triangular shape conjugate relative to the corresponding respective corner (7 or 7′), with an exposed side forming a concavely curved or straight functional or leading rim (6′). When the shape of the discharge opening (4) is square or rectangular, the portion of plate constituting the or each structure (6) will be able to have a right-angled triangular shape, the hypotenuse of which corresponds to the rim (6′). In contrast, when the shape of the discharge opening (4) is a parallelogram, the portion of plate will have any triangular shape whatsoever.

Advantageously, the two sides of the or each triangle constituting the obstructive structure (6), in contrast to the side forming a functional or leading rim (6′), extend respectively to approximately half of the width (L) and to approximately half of the height (H) of the discharge opening (4), in each case from the angle of the corresponding corner (7, 7′). Such an extension makes it possible to contribute beneficially to the sought effect.

Preferably, the two sides of the or each triangle constituting the obstructive structure (6), in contrast to the side forming a functional or leading rim (6′), extend respectively to a value between one fifteenth and one quarter of the width (L) and to a value between one eighth and one half of the height (H) of the discharge opening (4), in each case from the angle of the corresponding corner (7, 7′). Such an extension makes it possible to contribute beneficially and more to the sought effect.

According to a preferred first variant embodiment, illustrated in FIGS. 2 and 6, the obstructive structure (6) extends over the entire length of the second lateral rim (4″) and is advantageously constituted of two identical parts (8 and 8′), which are symmetric relative to the centerline extending to the half (H/2) of the height (H) of the discharge opening (4). These two parts (together as one single piece, or each corresponding to a separate piece) may advantageously have triangular shapes (with concave hypotenuses in the case of right-angled triangles) and be joined in such a way as to configure the second lateral rim with a concavely curved profile.

According to a second variant embodiment, illustrated in FIGS. 3 and 5, the obstructive structure (6) extends over the entire length of the second lateral rim (4″) and is constituted asymmetrically relative to the centerline at half height (H/2) of the opening (4).

Thus the obstructive structure (6) consists of at least one wall portion (8, 8′) defining the geometry of the second lateral rim (4″) of the discharge opening (4).

This wall portion is either in one piece with and integrated into the lateral wall (2″) of the tank (2) or attached as a separate part, which is fixed mechanically (screws, rivets) or by welding to the said lateral wall (2″), wherein the said or each integrated or attached wall portion (8, 8′) extends in the continuation of the said lateral wall (2″) and in a manner flush therewith. Such a construction with fixation by screws is shown more particularly in FIGS. 2 and 4 to 6.

The obstructive structure (6) may in particular be formed in a manner integrated into the lateral wall (2″) during cutting of the opening (4) therein, such as shown in FIG. 3.

FIG. 5 illustrates another exemplary embodiment of an obstructive structure (6), which is attached on the tank (2). It has a lower part with a very small surface and an upper part with a very large surface. The lower part extends from the angle of the lower corner (7) to at least one quarter of the width (L) and to at least half of the height (H) of the discharge opening (4), while the upper part extends from the angle of the upper corner (7) to more than one quarter of the width (L) and to more than one half of the height (H). By virtue of the particular profile of the functional rim (6′) of this obstructive structure (6), the quantity of product discharged is limited even if the slide (9) is completely open at the start of distribution when the tank (2) is full. This is an alternative to partial opening of the slide (9), such as shown in FIG. 4.

FIG. 6 shows another constructive variant of the obstructive structure (6), which is attached on the tank (2). The structure (6) here is composed of two parts or portions of identical plates (8, 8′), which are arranged symmetrically relative to the centerline, advantageously of triangles (preferably right-angled) having straight exposed sides (hypotenuses). The junction between the triangles (8, 8′) is made flush with the second lateral rim (4″). Thus the junction zone is very small and even nonexistent. According to one variant (not shown), the obstructive structure (6) is composed only of the lower plate part (8).

Direct discharge of product through the opening (4) may be provided, especially when the opening (4) is offset on one lateral side of the tank (2), as illustrated in FIG. 1. In the case of a mixer in particular, the product then falls directly onto the ground at the level of the animal feed alley, along feed fences.

However, the said equipment (1) may also comprise a device for transfer of the product emerging from the discharge opening (4), such as, for example, a conveyer that transports the product laterally to discharge it to the side, at some distance from the opening (4). In this case, the discharge opening (4) is generally centered and situated at the front of the tank (2).

As the figures also show, a sliding door or slide (9) is provided to close off the discharge opening (4), wherein guide rails (10 and 10′) are fixed on the outside of the lateral wall (2″) of the tank (2) along two opposite rims (4′ and 4″; 4′″ and 4″″) of the said opening (4), for horizontal or vertical displacement of the said slide (9) between a closed position and an open position of the discharge opening (4). In the illustrated variant embodiments, the slide (9) is capable of being displaced vertically, by sliding up or down along the wall in a trajectory that follows the wall of the tank (2). By virtue of the obstructive structure (6), no product is accumulated in the lower corner (7) of the discharge opening (4), and closing by the slide (9) can be achieved by downward translation, without intervention by the driver.

Advantageously, the obstructive structure (6) such as represented in the figures, with the exception of FIG. 3, is attached as a separate piece and is fixed mechanically by means of screws that fix the guide rail of the slide (9) at the level of the second lateral rim (4″).

In the distribution mode shown in FIGS. 1 to 3 as well as 5 and 6, the slide (9) is shown in its retracted position, in which the discharge opening (4) is completely clear. The control actuator (9′) of the slide (9) is retracted. According to the distribution mode shown in FIG. 4, the slide (9) is open only to approximately half height. Thus the quantity of product distributed to begin with when the tank (2) is full is limited. The driver may modify the opening height of the slide (9) by means of the control actuator (9′), which is advantageously hydraulic.

Furthermore, concerning the known agricultural equipment for distribution of products, some may comprise chamfers (11) in the lower corners (at least one chamfer (11) in one or other of the said lower corners) of the discharge opening (4) (only at the bottom), which chamfers have the purpose of facilitating closing of the door after the distribution of a mixture that includes long fibers. These chamfers (11) achieve a kind of guillotine function, making it possible to limit the accumulation of fibers and thus incomplete closing of the door. The obstructive structure or structures (6) according to the present invention have another purpose, which may be complementary to that of these chamfers and is intended to ensure a more regular flow during distribution of the mixture. As may be seen in FIGS. 1 to 6, the present invention is able to provide such chamfers (11) if need be.

Of course, the invention is not limited to the embodiment described and to the different variants described and shown in the attached drawings. Modifications are still possible especially from the viewpoint of the constitution of the various elements or by substitution of equivalent techniques, without departing from the scope of protection of the invention.

1. An agricultural equipment for distribution of product, said agricultural equipment comprising a tank having a bottom and a lateral wall, mounted on a chassis and provided with at least one discharge opening made in said lateral wall and defining a passage of general quadrilateral, wherein a rotary drive mechanism that conveys the product through the opening is mounted in said tank and defines the first and second lateral rims of said opening in the direction of rotation of said mechanism,
wherein said discharge opening (4) is provided in the region of said second lateral wall with at least one surface-occupying or volume-occupying obstructive structure that reduces the passage cross section of said opening and/or determines the geometry of said second rim at least partly.

2. The agricultural equipment according to claim 1, wherein the reduction of the passage cross section of the discharge opening resulting from the presence of said at least one obstructive structure is greater than 2% and less than 20% of said passage cross section.

3. The agricultural equipment according to claim 1, wherein the obstructive structure is situated at least partly at the level of the lower corner of the discharge opening formed between the second lateral rim and the lower longitudinal rim of the opening, which is situated in the plane of the bottom of the tank, and includes a portion of plate having a triangular shape conjugate relative to said corner, with an exposed side forming a concavely curved or straight functional or leading rim.

4. The agricultural equipment according to claim 1, wherein the obstructive structure is situated at least partly at the level of the upper corner of the discharge opening formed between the second lateral rim and the upper longitudinal rim of said opening, and includes a portion of plate having a triangular shape conjugate relative to said corner, with an exposed side forming a concavely curved or straight functional or leading rim.

5. The agricultural equipment according to claim 3, wherein the two sides of the or each triangle constituting the obstructive structure, in contrast to the side forming a functional or leading rim, extend respectively to approximately half of the width and to approximately half of the height of the discharge opening, in each case from the angle of the corresponding corner.

6. The agricultural equipment according to claim 3, wherein the two sides of the or each triangle constituting the obstructive structure, in contrast to the side forming a functional or leading rim, extend respectively to a value between one fifteenth and one quarter of the width and to a value between one eighth and one half of the height of the discharge opening, in each case from the angle of the corresponding corner.

7. The agricultural equipment according to claim 3, wherein the obstructive structure extends over the entire length of the second lateral rim and is constituted of two identical parts, which are symmetric relative to the centerline extending to the half of the height of the discharge opening.

8. The agricultural equipment according to claim 1, wherein the obstructive structure is attached on the tank and has a lower part with a very small surface and an upper part with a very large surface, wherein said lower part extends from the angle of the lower corner to at least one quarter of the width and to at least half of the height of the discharge opening, while the upper part extends from the angle of the upper corner to more than one quarter of the width and to more than one half of the height.

9. The agricultural equipment according to claim 1, wherein the obstructive structure consists of at least one wall portion defining the geometry of the second lateral rim of the discharge opening, wherein said wall portion is either in one piece with and integrated into the lateral wall of the tank or attached as a separate part, which is fixed mechanically or by welding to said lateral wall, wherein said or each integrated or attached wall portion extends in the continuation of said lateral wall and in a manner flush therewith.

10. The agricultural equipment according to claim 1, it wherein the agricultural equipment comprises a sliding door or slide to close off the discharge opening, wherein guide rails are fixed on the outside of the lateral wall of the tank along two opposite rims of said opening, for horizontal or vertical displacement of said slide between a closed position and an open position of the discharge opening.

11. The agricultural equipment according to claim 1, wherein the agricultural equipment comprises at least one rotary mechanism mounted in the tank.

12. The agricultural equipment according to claim 1, wherein the agricultural equipment comprises a device for transfer of the product emerging from the discharge opening.
